(19) United States
(12) Patent Application Publication
(10) Pub. No.: US 2018/0024716 A1
(43) Pub. Date: Jan. 25, 2018

(54) CARTOON DATA DISPLAYING METHOD AND CARTOON DATA DISPLAY DEVICE

(71) Applicant: NAVER CORPORATION, Seongnam-si (KR)

(72) Inventors: Hyo Kim, Seongnam-si (KR); Hyun Chul Lee, Seongnam-si (KR); Ji Han Kim, Seongnam-si (KR); Dai Hyun Lim, Seongnam-si (KR); Byoung Kwan Kim, Seongnam-si (KR)

(73) Assignee: NAVER CORPORATION, Seongnam-si (KR)

(21) Appl. No.: 15/546,561

(22) PCT Filed: Nov. 24, 2015
(86) PCT No.: PCT/KR2015/012653

§ 371 Date: Jul. 27, 2017

(30) Foreign Application Priority Data
Jan. 27, 2015 (KR) 10-2015-0012848

(51) Int. Cl. G06F 3/0485

(52) U.S. Cl. CPC G06F 3/0485; G06F 2203/04803

(57) ABSTRACT

An embodiment of the present invention discloses a cartoon data display method in which cartoon data is displayed on a display unit of a cartoon data display device. The cartoon data display method includes displaying, by the display unit, a partial region of first cartoon data; receiving, by a user input unit, a command for automatically scrolling the first cartoon data from a first user; determining, by a control unit, an automatic scroll speed corresponding to cartoon reading information of the first user; and controlling, by the control unit, the display unit according to the command such that the first cartoon data is automatically scrolled at the determined automatic scroll speed.

### CROSS-REFERENCE TO RELATED APPLICATIONS

This is a continuation application of International Application No. PCT/KR2015/012653, filed Nov. 24, 2015, which claims benefit of Korean Patent Application No. 10-2015-0012848, filed Jan. 27, 2015.

### BACKGROUND OF THE INVENTION

### Field of Invention

The present invention relates to a device and method for displaying cartoon data.

### Description of Related Art

Cartoons are drawings that satirize and criticize human life or society or arouse readers' interests by exaggerating or omitting characteristics of characters through jokes, humor, satire, or the like, and are classified into various genres such as romance cartoons, oriental fantasy cartoons, action cartoons, comedy cartoons, sports cartoons, science fiction (SF) cartoons, and the like. Cartoons use a visual system, i.e., images and text, to visually describe complicated situations, and thus are more effective in attracting the attention of a reader than general books simply consisting of only letters.

Recently, with the development of communication technology, cartoons are being delivered through the Internet or the like and have escaped from a traditional cartoon book.

The foregoing background is technical information the inventors possessed for or obtained in the course of the present invention and thus may not be publicly known before the filing of this application.

There is a need to automatically scroll cartoon data on a display unit of a cartoon data display device in response to an automatic scroll command. There is also a need to determine an automatic scroll speed according to cartoon reading information of a user and scroll cartoon data at the determined automatic scroll speed. There is also a need to determine an automatic scroll speed according to a cartoon reading speed of a user, whether the user has previously read cartoon data, or information directly entered by the user, and scroll the cartoon data by a distance proportional to the determined automatic scroll speed per unit of time.

### BRIEF SUMMARY OF THE INVENTION

An embodiment of the present invention discloses a cartoon data display method in which cartoon data is displayed on a display unit of a cartoon data display device. The cartoon data display method includes displaying, by the display unit, a partial region of first cartoon data, receiving, by a user input unit, a command for automatically scrolling the first cartoon data from a first user, determining, by a control unit, an automatic scroll speed corresponding to cartoon reading information of the first user, and controlling, by the control unit, the display unit according to the command such that the first cartoon data is automatically scrolled at the determined automatic scroll speed.

Another embodiment of the present invention discloses a cartoon data display method in which cartoon data is displayed on a display unit of a cartoon data display device. The cartoon data display method includes displaying, by the display unit, a partial region of first cartoon data, receiving, by a user input unit, a command for scrolling the first cartoon data from a first user, detecting, by a control unit, when a first specific region is displayed on the display unit while the first cartoon data is scrolled according to the command, and controlling, by the control unit, the display unit such that the first cartoon data is automatically scrolled from the first specific region to a second specific region.

Still another embodiment of the present invention discloses a cartoon data display device including a display unit configured to display first cartoon data, a user input unit configured to receive a command for automatically scrolling the first cartoon data from a first user, and a control unit configured to determine an automatic scroll speed corresponding to cartoon reading information of the first user and control the display unit such that the first cartoon data is automatically scrolled on the display unit at the determined automatic scroll speed.

The above and other aspects, features, and advantages of the present invention will become apparent from the following description taken in conjunction with the accompanying drawings, claims, and detailed description.

The present invention may provide a cartoon data display method and device capable of automatically scrolling cartoon data in response to an automatic scroll command of a user.

The present invention may also provide a cartoon data display method and device capable of determining an automatic scroll speed according to cartoon reading information of a user and scrolling the cartoon data at the determined automatic scroll speed.

The present invention may also provide a cartoon data display method and device capable of determining an automatic scroll speed according to a cartoon reading speed of a user, whether the user has previously read cartoon data, or information directly entered by the user, and scrolling the cartoon data by a distance proportional to the determined automatic scroll speed per unit of time.

### BRIEF DESCRIPTION OF THE DRAWINGS

FIG. 1 is a diagram schematically illustrating a configuration of a system for displaying cartoon data according to an embodiment of the present invention.

FIG. 2 is a block diagram schematically showing an internal configuration of a device for displaying cartoon data according to an embodiment of the present invention.

FIG. 3 is a flowchart showing a method of displaying cartoon data according to an embodiment of the present invention.

FIGS. 4A and 4B are diagrams schematically showing an example of cartoon data and an example in which cartoon data is displayed on a display device.

FIGS. 5, 6A-6C, 7 and 8 are diagrams schematically illustrating an example process in which cartoon data is displayed on a device for displaying cartoon data according to an embodiment of the present invention.

### DETAILED DESCRIPTION OF THE INVENTION

While the invention is susceptible to various modifications and alternative forms, specific embodiments thereof are shown by way of example in the drawings and will herein be described in detail. Advantages and features of the present invention and implementation methods thereof will be clarified through following embodiments described with reference to the accompanying drawings. However, the present invention is not limited to the following embodiments and may be implemented in various forms. It should be understood that although the terms “first,” “second,” etc. may be used herein to describe various components, these components are not limited by these terms. These components are only used to distinguish one component from another. The singular forms “a,” “an,” and “the” include the plural form unless the context clearly dictates otherwise. It should be further understood that the terms “comprises” and/or “comprising” used herein specify the presence of stated features or components, but do not preclude the presence or addition of one or more other features or components. Additionally, sizes of components depicted in the drawings may be exaggerated or reduced for convenience of explanation. For example, since sizes and thicknesses of components in the drawings are arbitrarily illustrated for convenience of explanation, the following embodiments are not limited thereto.

Hereinafter, embodiments of the present invention will be described in detail with reference to the accompanying drawings, and the same or similar elements are designated with the same numeral references regardless of the numerals in the drawings, and redundant descriptions thereof will be omitted.

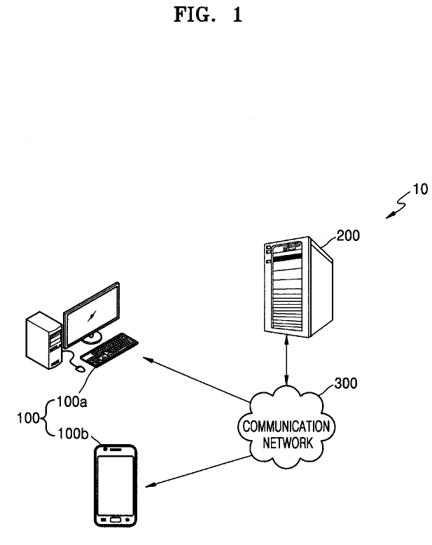

FIG. 1 is a diagram schematically illustrating a configuration of a system for displaying cartoon data according to an embodiment of the present invention.

Referring to FIG. 1, a cartoon data display system 10 according to an embodiment of the present invention includes a cartoon data display device 100. Also, the cartoon data display system 10 includes a server 200. Also, the cartoon data display system 10 includes a communication network 300 configured to connect the cartoon data display device 100 and the server 200.

The cartoon data display device 100 is configured to display cartoon data. The cartoon data display device 100 may refer to a communication terminal configured to transmit and receive data to and from other devices in a wired or wireless communication environment. The cartoon data display device 100 may refer to various devices configured to display cartoon data present in an internal or external memory on a display unit of the cartoon data display device 100. The cartoon data display device 100 connected to the communication network 300 may be provided in plurality. In FIG. 1, the cartoon data display device 100 is shown as a first cartoon data display device 100a in the form of a smartphone and a second cartoon data display device 100b in the form of a desktop, but the present invention is not limited thereto.

In detail, the cartoon data display device 100 may include a smartphone, a personal computer (PC), a tablet PC, a smart TV, a cell phone, a personal digital assistant (PDA), a laptop, a media player, a micro server, a Global Positioning System (GPS) device, an e-book terminal, a digital broadcasting terminal, a navigation device, a kiosk, an MP3 player, a digital camera, a wearable device, and other mobile or non-mobile computing devices, but the present invention is not limited thereto.

Also, the cartoon data display device 100 may include various devices configured to receive a touch input, such as an interactive whiteboard, a touch table, or the like. Also, the cartoon data display device 100 may be an accessory, such as a wrist watch, eyeglasses, a hair band, and a ring, having a communication function or a data processing function.

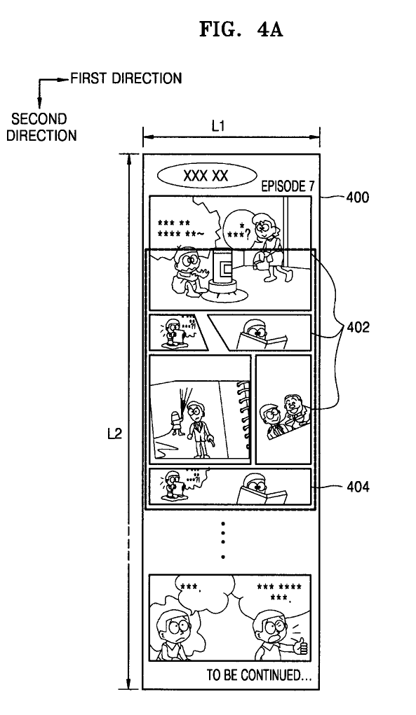

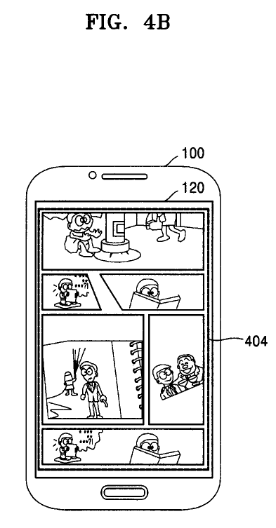

In this specification, the cartoon data may refer to an object that may be visually perceived as letters (an alphabet), pictures, photos, or the like and that may visually transfer information to a viewer, or image data composed of a set of such objects. The cartoon data may be data created by a cartoon artist and may include a plurality of visual objects in an installment offered at one time. One piece of cartoon data may include one or more frames. Here, a frame, which is data including a scene of a single cartoon, may include a plurality of layers including images or text. An example of the cartoon data and an example in which the cartoon data is displayed on the cartoon data display device 100 will be described with reference to FIGS. 4A and 4B.

The server 200 is configured to provide cartoon data to the cartoon data display device 100. The server 200 stores the cartoon data to be provided to the cartoon data display device 100. A single server is shown in FIG. 1, but multiple servers may be present depending on the number of accesses or the amount of data.

The server 200 may receive user-associated information of the cartoon data display device 100 from the cartoon data display device 100 or may generate the information for itself. Also, the server 200 may have the user-associated information of the cartoon data display device 100 stored therein. In this case, the server 200 may store the user-associated information separately depending on different cartoon data display devices 100. For example, the server 200 may store first cartoon reading information associated with the first cartoon data display device 100a and also store second cartoon reading information associated with the second cartoon data display device 100b. As another example, the server may store third cartoon reading information associated with a first account and also store fourth cartoon reading information associated with a second account. That is, the server 200 may identify the user-associated information on the basis of whether devices that display cartoon data are different and may identify the user-associated information on the basis of different accounts which request that cartoon data be displayed.

The server 200 may provide a general search service and various other services for enhancing user convenience other than a service associated with cartoon data. That is, the server 200 may provide various services such as a search service, an email service, a blog service, a social network service, a news service, and a shopping information provision service in addition to the service associated with cartoon data.

Alternatively, the server 200 may be a server connected to a server for providing a portal service, such as a search service, an email service, a news service, and a shopping service, and configured to provide a web page on which the portal service is offered to the cartoon data display device 100 that requests information be provided from the portal service. Here, the server 200 and the portal service providing server may be physically separated from each other and provided as separate servers or may only be conceptually separated from each other and provided as a single server.

The communication network 300 serves to connect the cartoon data display device 100 and the server 200. That is, the communication network 300 is configured to provide an access path through which the cartoon data display device 100 and the server 200 transmit and receive data including the cartoon data. For example, the communication network 300 may include wired networks such as local area networks (LANs), wide area networks (WANs), metropolitan area networks (MANs), and integrated services digital networks (ISDNs) or wireless networks such as wireless LANs, CDMA, Bluetooth, and satellite communication, but the scope of the present invention is not limited thereto.

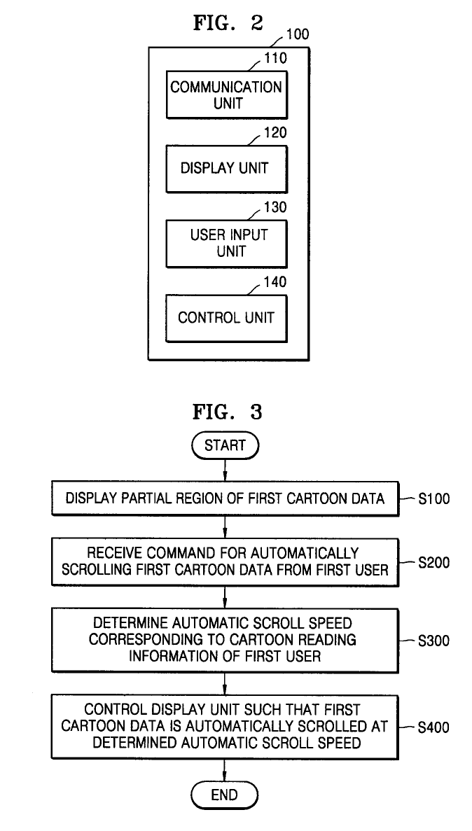

FIG. 2 is a block diagram schematically showing an internal configuration of a device for displaying cartoon data according to an embodiment of the present invention.

Referring to FIG. 2, the cartoon data display device 100 of the cartoon data display system 10 according to an embodiment of the present invention includes a display unit 120, a user input unit 130, and a control unit 140. Also, the cartoon data display device includes a communication unit 110.

The communication unit 110 is configured to communicate with at least one of the server 200 and an external device in a wired or wireless manner. The communication unit 110 may include, but is not limited to, a Bluetooth communication unit, a Bluetooth low energy (BLE) communication unit, a near field communication unit, a wireless LAN (WLAN) communication unit, a ZigBee communication unit, an Infrared Data Association (IrDA) communication unit, a Wi-Fi Direct (WFD) communication unit, an ultra wideband (UWB) communication unit, and an Ant+ communication unit.

The communication unit 110 may transmit and receive radio signals to and from a base station, the server 200, and an external device over the communication network 300. The radio signals may include various types of data including the cartoon data. That is, the communication unit 110 may receive cartoon data transmitted from the server 200. Also, the communication unit 110 may receive cartoon reading information for a user of an external device from the external device. Also, the communication unit 110 may transmit user-associated information to the server 200 and may receive user-associated information from the server 200.

The communication unit 110 may be a device including hardware and software needed to transmit and receive a signal such as a control signal or a data signal through wired/wireless connection with a base station, the server 200, or an external device.

The display unit 120 displays information processed by the cartoon data display device 100. The display unit 120 may display cartoon data and may move the cartoon data according to a user input for the cartoon data. In detail, the cartoon data may be large-scale image data, which is difficult to entirely display on the display unit 120 at one time. Accordingly, the display unit 120 may display only a partial region of the cartoon data at one time. Also, the display unit 120 may scroll the cartoon data to display another partial region of the cartoon data.

In this specification, an action of scrolling the cartoon data may refer to an action of changing a state in which a first region of the cartoon data is displayed on the display unit 120 to a state in which a second region different from the first region is displayed on the display unit 120. While the cartoon data is being scrolled, frames included in the first region or the second region and frames positioned between the first region and the second region may be displayed on the display unit 120 for a certain time or longer.

The display unit 120 may include at least one of a liquid crystal display (LCD), a thin film transistor-LCD (TFT-LCD), an organic light-emitting diode (OLED) display, a flexible display, a three-dimensional (3D) display, and an electrophoretic display, but the scope of the present invention is not limited thereto. The cartoon data display device 100 may include two or more display units according to an implementation of the cartoon data display device 100.

The user input unit 130 refers to a means for a user to input data for controlling the cartoon data display device 100. For example, the user input unit 130 may include, but is not limited to, a key pad, a dome switch, a touchpad (a contact capacitance type touchpad, a pressure resistance type touchpad, an infrared sensing type touchpad, a surface ultrasonic wave conduction type touchpad, an integral tension measurement type touchpad, a piezoelectric effect type touchpad, etc.), a jog wheel, a jog switch, a mouse, etc.

The user input unit 130 may receive or detect a user input for the cartoon data. For example, the user input unit 130 may receive or detect an input for displaying the cartoon data. Also, while a partial region of the cartoon data is displayed on the display unit 120, the user input unit 130 may receive or detect an input for displaying another partial region of the cartoon data. Also, the user input unit 130 may detect or receive an input for scrolling the cartoon data from a user. The input for scrolling the cartoon data may be a command for displaying a partial region of the cartoon data while another partial region of the cartoon data is displayed. In this case, the speed or distance of the scrolled cartoon data may be determined according to an input type or an input duration time. Also, while a partial region of the cartoon data is displayed on the display unit 120, the user input unit 130 may receive or detect an input for automatically scrolling the cartoon data.

The user input unit 130 may be a device configured to provide a touch input of a user, a click input of the user through a mouse, an input of the user through a keyboard, or a voice input of the user, a device configured to receive the inputs, or a device configured to detect the inputs, but the scope of the present invention is not limited thereto.

The user input unit 130 may be configured as a single touchscreen by forming a layered structure along with the display unit 120. In this case, the display unit 120 and the user input unit 130 may be provided in a single physical form.

The control unit 140 controls the overall operation of the cartoon data display device 100. For example, the control unit 140 may generally control the communication unit 110, the display unit 120, the user input unit 130, and the like by executing programs stored in a memory included in the cartoon data display device 100. In this case, the memory may include magnetic storage media or flash storage media, but the scope of the present invention is not limited thereto. The control unit 140 may generally control the communication unit 110, the display unit 120, the user input unit 130, and the like to perform operations of the cartoon data display device 100 of FIGS. 1 to 8.

The control unit 140 may include any type of device capable of processing data, such as a processor. Here, the processor may refer to a hardware built-in data processing device having a circuit physically structured to perform a function expressed in a code or instructions included in a program. Examples of the hardware built-in data processing device may include processing devices such as a microprocessor, a central processing unit (CPU), a processor core, a multiprocessor, an application-specific integrated circuit (ASIC), a field programmable gate array (FPGA), etc., but the scope of the present invention is not limited thereto.

The control unit 140 may control the display unit 120 such that the cartoon data is displayed on the display unit 120. The control unit 140 may control the display unit 120 such that a partial region of the cartoon data is displayed on the display unit 120. When a command for displaying the cartoon data is received from a user, the control unit 140 may control the display unit 120 such that the partial region of the cartoon data is displayed on the display unit 120. In this case, the control unit 140 may control the display unit 120 such that the first portion of the cartoon data is displayed on the display unit 120. When the user has previously read up to a middle portion of the cartoon data, the control unit 140 may control the display unit 120 such that the middle portion of the cartoon data is displayed on the display unit 120.

The control unit 140 may determine an automatic scroll speed corresponding to cartoon reading information of the user. The cartoon reading information of the user may include a cartoon reading speed of the user, whether the user has previously read the cartoon data, or input information that is directly entered by the user. The cartoon reading information of the user may be acquired by the control unit 140 analyzing cartoon reading patterns of the user, received from the server 200, an external memory, or an external device, or stored in an internal memory included in the cartoon data display device 100.

The control unit 140 may analyze at least one of the cartoon reading patterns of the user to acquire cartoon reading information. The cartoon reading patterns of the user may include an average time for the user to read a cartoon, a cartoon genre or a cartoon series frequently read by the user, a type of frame quickly or slowly scrolled past by the user, the number of scrolls while the user reads cartoon data, a position at which a scroll is carried out, a direction in which a scroll is carried out, the number of scrolls carried out in a reverse direction, a position at which a scroll is carried out in the reverse direction, a time at which a scroll is carried out in the reverse direction, a type or genre of cartoon data the user repeatedly reads, a type or genre of cartoon data the user stopped reading, whether a comment is written after the user reads cartoon data, whether a comment written by the user is positive or negative, whether a feedback provided for the cartoon data by the user is positive or negative, a place at which the user reads the cartoon data, or a time during which the user reads the cartoon data. The control unit 140 may analyze the cartoon reading patterns of the user to acquire cartoon reading information needed to determine an automatic scroll speed for the user.

While the cartoon reading patterns are analyzed to acquire the cartoon reading information, the control unit 140 may not consider some of the cartoon reading patterns. For example, the control unit 140 may analyze cartoon reading patterns except for the number of scrolls carried out in the reverse direction while the cartoon data is read, the period during which a scroll is carried out in the reverse direction, or a reading time added due to a scroll in the reverse direction. Thus, it is possible to acquire the cartoon reading information excepting a time consumed regardless of cartoon reading capability of the user. As another example, when an input such as a click, a touch, or a dragging is not received from the user for a certain time or longer, the control unit 140 may analyze the cartoon reading patterns except for a period from when an input is not received to when an input is received again. Also, the control unit 140 may exclude a period during which the cartoon data is not displayed on the display unit 120 from a time for the user to read a cartoon and then analyze the cartoon reading pattern. Thus, it is possible to acquire the cartoon reading information excepting a time consumed because the user stopped reading to temporarily leave or carry out another task.

The control unit 140 may determine a different automatic scroll speed for each region of the cartoon data. For example, the control unit 140 may determine an automatic scroll speed for the first region of the cartoon data as a first automatic scroll speed and also determine an automatic scroll speed for the second region as a second automatic scroll speed. Subsequently, the control unit 140 may control the display unit 120 such that a first region of first cartoon data is scrolled at the first automatic scroll speed and a second region thereof is scrolled at the second automatic scroll speed. Thus, the control unit 140 may determine an automatic scroll speed appropriate for each of the regions in consideration of the characteristics of each of the regions of the cartoon data.

The control unit 140 may determine the automatic scroll speed in consideration of the cartoon reading speed of the user. The cartoon reading speed of the user may include an average cartoon reading speed of the user, a cartoon reading speed with respect to the same genre as that of the cartoon data for which the automatic scroll speed is to be determined, a cartoon reading speed with respect to the same series as that of the cartoon data for which the automatic scroll speed is to be determined, or a cartoon reading speed with respect to other cartoon data created by an artist of the cartoon data for which the automatic scroll speed is to be determined. The control unit 140 may determine the automatic scroll speed to be proportional to the cartoon reading speed of the user. Thus, the control unit 140 may determine the automatic scroll speed in consideration of the reading speed of the user.

The control unit 140 may determine the automatic scroll speed in consideration of whether the user has previously completed reading the cartoon data for which the automatic scroll speed is to be determined. The control unit 140 may determine a higher automatic scroll speed when the user has previously read the cartoon data than when the user first reads the cartoon data. Thus, the control unit 140 may determine the automatic scroll speed in consideration of the user's experience regarding completion of the reading.

The control unit 140 may determine the automatic scroll speed in consideration of whether the user has previously stopped reading the cartoon data for which the automatic scroll speed is to be determined. The control unit 140 may determine a higher automatic scroll speed before a first position of the cartoon data when the user has previously stopped reading the cartoon data at the first position than when the user first reads the cartoon data. In this case, the control unit 140 may not consider the previous reading experience when an automatic scroll speed after the first position is determined. Thus, the control unit 140 may determine the automatic scroll speed in consideration of the user's experience regarding stoppage of the reading.

The control unit 140 may determine the automatic scroll speed in consideration of information directly entered by the user. The information directly entered by the user may include a cartoon reading speed of the user that is indicated by the user, a reading speed of the user (other than the cartoon reading speed of the user) that is indicated by the user, an age of the user, a favorite cartoon genre of the user, a scene the user desires to view for a longer time or a scene the user desires to view for a shorter time, a favorite picture type of the user, or a cartoon reading habit of the user. The control unit 140 may determine the automatic scroll speed to be proportional to the cartoon reading speed or the reading speed of the user that is thought by the user. The control unit 140 may determine a lower automatic scroll speed when cartoon data to be automatically scrolled is the favorite cartoon genre of the user than when the cartoon data is not the favorite cartoon genre. The control unit 140 may determine a lower automatic scroll speed when the type of scene the user desires to view for a longer time appears in the cartoon data to be automatically scrolled than when the type of scene the user desires to view for a longer time does not appear. Thus, the control unit 140 may determine the automatic scroll speed in consideration of a direct or indirect request from the user.

The control unit 140 may determine the automatic scroll speed in consideration of the age or other characteristics of the user. For example, when the user is under 19 years of age, the control unit 140 may not display, on the display unit 120, a scene determined as not being appropriate for people under 19 years of age among scenes of the cartoon data. As another example, when the user is a pregnant or elderly person, the control unit 140 may not display, on the display unit 120, a scene determined as not being appropriate for such a person among the scenes of the cartoon data. The control unit 140 may set a scroll speed for the scene determined as not being displayed on the display unit to be very high or may set the determined scene to be skipped during the scroll. Thus, the control unit 140 may determine the automatic scroll speed such that a scene not appropriate for the user is displayed on the display unit 120 for a very short time or not at all.

The control unit 140 may determine the automatic scroll speed in consideration of characteristics of each of the regions of the cartoon data for which an automatic scroll speed is to be determined. The control unit 140 may determine the automatic scroll speed in consideration of at least one of the number of frames included in each of the regions of the cartoon data, frame details, a size of a frame, a degree to which an image included in a frame is complicated, whether an effect is present, the number of effects present, a type of effect present, a type of person, an object, or a background appearing in a frame, the number of people or objects appearing in a frame, whether text is included, the number of letters of included text, a font size of included text, a font type of included text, and whether advertising content is included. For example, the control unit 140 may determine a lower automatic scroll speed when advertising content is included in a specified region of the cartoon data than when advertising content is not included. Thus, the control unit 140 may determine the automatic scroll speed according to the characteristics of each of the regions.

The control unit 140 may determine an automatic scrolling speed corresponding to data set by an artist. The data set by an artist may include an importance level set by the artist for each of the regions of the cartoon data or an animation effect replay time set by the artist for each of the regions of the cartoon data. The data set by an artist may be received from the server 200, an external memory, or an external device, or may be stored in a memory included in the cartoon data display device 100.

The control unit 140 may determine the automatic scroll speed in consideration of an importance level set for each of the regions of the cartoon data by the artist. The control unit 140 may determine an automatic scroll speed for each of the regions to be inversely proportional to the importance level set for each of the regions by the artist. Thus, the control unit 140 may determine the automatic scroll speed in consideration of what the artist thinks is important and what the artist does not think is important.

The control unit 140 may determine the automatic scroll speed in consideration of an animation effect replay time set by the artist for each of the regions of the cartoon data. The control unit 140 may determine an automatic scroll speed for each of the regions to be inversely proportional to the animation effect replay time set for each of the regions of the cartoon data by the artist. Thus, the control unit 140 may determine the automatic scroll speed to be a speed at which the user may notice all animation effects.

The control unit 140 may determine the automatic scroll speed in consideration of cartoon reading information of a user of an external device from the external device. That is, the control unit 140 may consider the cartoon reading information of the user who uses the external device while the cartoon data display device 100 determines the automatic scroll speed for the user.

The control unit 140 may determine the automatic scroll speed in consideration of two or more of the cartoon reading speed of the user, the previous reading experience of the user, the information directly entered by the user, the characteristics for each of the regions of the cartoon data, the data set by an artist, and the cartoon reading speed of the user of the external device.

When a command for automatically scrolling the cartoon data is received from the user, the control unit 140 may control the display unit 120 such that the regions of the cartoon data are sequentially displayed on the display unit 120. In this case, a time for which each of the regions is displayed on the display unit 120 may be proportional to the automatic scroll speed. The control unit 140 may control the display unit such that the cartoon data is scrolled by a moving distance proportional to the automatic scroll speed per unit of time.

When the cartoon data is automatically scrolled to the last position thereof, the control unit 140 may control the display unit 120 such that other cartoon data subsequent to the cartoon data is automatically displayed on the display unit 120. That is, the control unit 140 may control the display unit 120 such that cartoon data in the same series as and subsequent to the cartoon data scrolled to the last position is displayed on the display unit 120. Thus, the control unit 140 may control the display unit 120 such that the user continuously reads a plurality of pieces of cartoon data included in one series.

The automatic scroll speed determined by the control unit 140 may be transmitted to the server 200 through the communication unit 110. In this case, the server 200 may store automatic scroll speeds received from different devices separately depending on the devices, and may also store automatic scroll speeds from different accounts separately depending on the accounts. The process of determining the automatic scroll speed may be determined by the server 200. That is, the server 200 may determine an automatic scroll speed for each user by using cartoon reading speeds of the users, previous cartoon reading experiences of the users, or input information directly entered by the users.

Even when an automatic scroll command is not received from a user, the control unit 140 may control the display unit 120 such that the cartoon data is automatically scrolled when a certain condition is satisfied. For example, the control unit 140 may detect when a first specific region is displayed on the display unit 120. When the first specific region is detected as being displayed, the control unit 140 may control the display unit 120 such that the cartoon data is automatically scrolled from the first specific region to a second specific region. Thus, the control unit 140 may control the display unit 120 such that the cartoon data is automatically scrolled at a certain portion thereof. Such a function may be used to show an effect desired by an artist of the cartoon data on the cartoon data display device 100. In this case, the speed for the automatic scroll may be determined as a speed directly set by the artist and also may be determined as an automatic scroll speed determined by the control unit 140. As another example, when an input is not received through the user input unit 130 for a certain time while the cartoon data is displayed on the display unit 120, the control unit 140 may control the display unit 120 such that the cartoon data is automatically scrolled.

When the cartoon data display device 100 receives an input for scrolling the cartoon data from the user, the cartoon data display device 100 may request an automatic scroll speed for the user from the server 200. In this case, the server 200 may transmit the automatic scroll speed for the user to the cartoon data display device 100.

FIG. 3 is a flowchart showing a method of displaying cartoon data according to an embodiment of the present invention.

The flowchart shown in FIG. 3 is composed of steps processed in time series by the cartoon data display device 100 shown in FIG. 2. Accordingly, it can be seen that the above-descriptions of the elements shown in FIG. 2 may be applied to the flowchart shown in FIG. 3 although the elements are not described below with reference to FIG. 3.

Referring to FIG. 3, a cartoon data display method according to an embodiment of the present invention includes displaying a partial region of first cartoon data (S100), receiving a command for automatically scrolling the first cartoon data from a first user (S200), determining an automatic scroll speed corresponding to cartoon reading information of the first user (S300), and controlling a display unit such that the first cartoon data is automatically scrolled at the determined automatic scroll speed (S400).

The cartoon data display method may further include acquiring cartoon reading data by analyzing at least one of previous cartoon reading patterns of the first user before the determining step S300. The cartoon data display method may further include receiving cartoon reading information of a second user from an external device before the determining step S300. In the determining step S300, automatic scroll speeds corresponding to the cartoon reading information of the first and second users may be determined. The cartoon data display method may further include controlling the display unit such that second cartoon data in the same series as and subsequent to the first cartoon data is displayed on the display unit before the controlling step S400.

Also, the cartoon data display method according to an embodiment of the present invention may include acquiring the cartoon reading information by analyzing at least one of the previous cartoon reading patterns of the first user, receiving the command for automatically scrolling the first cartoon data from the first user, and determining an automatic scroll speed corresponding to characteristics of the first cartoon data and also corresponding to the acquired cartoon reading information of the first user.

FIGS. 4A and 4B are diagrams schematically showing an example of cartoon data and an example in which the cartoon data is displayed on a display device.

Referring to FIGS. 4A and 4B, cartoon data 400 may include a plurality of frames 402. A partial region 404 of the cartoon data 400 may be displayed on the display unit 120 of the cartoon data display device 100.

The cartoon data 400 may be image data in the form of a rectangle having a first length L1 in a first direction and a second length L2 in a second direction perpendicular to the first direction. In this case, the second length L2 may be significantly longer than the first length L1.

The cartoon data 400 may include the plurality of frames 402. The plurality of frames 402 may be an object, or a set of objects, that may be visually perceived as letters, pictures, photos, or the like and that may visually transfer information to a viewer

The partial region 404 of the cartoon data 400 may be displayed on the display unit 120 of the cartoon data display device 100. That is, the cartoon data 400 may be large-scale image data, which is difficult to entirely display on the display unit 120 of the cartoon data display device 100 at one time. Also, the cartoon data 400 may be image data having the second length L2 significantly longer than the first length L1. Accordingly, only the partial region 404 of the cartoon data 400 may be displayed on the display unit 120 of the cartoon data display device 100 at a moment, and other regions of the cartoon data 400 may be displayed on the display unit 120 of the cartoon data display device 100 at different moments.

FIG. 4A merely shows an example of the cartoon data. The cartoon data may be image data having the form of a polygon or circle instead of a rectangle and also include sound data as well as image data. However, the present invention is not limited thereto.

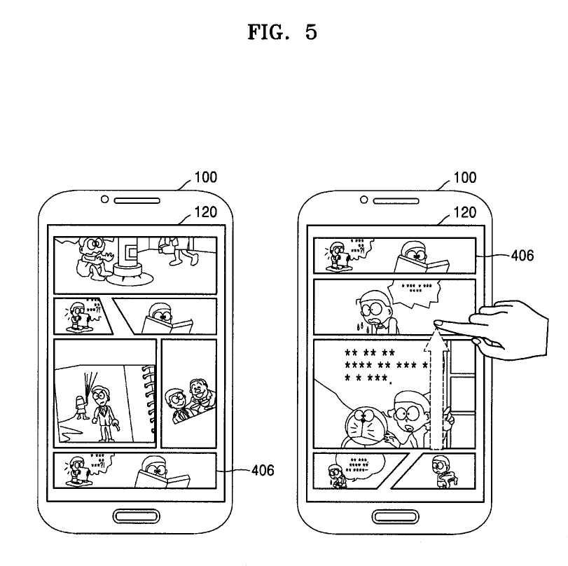

FIGS. 5 to 8 are diagrams schematically illustrating an example process in which cartoon data is displayed on a device for displaying cartoon data according to an embodiment of the present invention.

Referring to FIGS. 5 to 8, the cartoon data display device 100 may display cartoon data on the display unit 120 on the basis of various inputs from a user or an internal algorithm of the cartoon data display device 100.

The cartoon data display device 100 may receive a user input for scrolling the cartoon data while a region of the cartoon data is displayed on the display unit 120 and may display another region of the cartoon data on the display unit 120. For example, as shown in the first drawing on the left side of FIG. 5, the cartoon data display device 100 may display a region of the cartoon data while a first frame 406 is displayed on a bottom portion of the display unit 120. In this case, the cartoon data display device 100 may receive a user input for scrolling the cartoon data. For example, as shown in the second drawing on the right side of FIG. 5, the cartoon data display device 100 may detect an action of a user touching and dragging the display unit 120. When the dragging action is detected, the cartoon data display device 100 may move the displayed cartoon data by a distance corresponding to the dragging action on the display unit 120. For example, as shown in the second drawing of FIG. 5, the cartoon data display device 100 may display another region of the cartoon data while the first frame 406 is displayed on a top portion of the display unit 120. A degree to which the cartoon data is scrolled may be proportional to a length of the dragging of the user. Thus, the cartoon data display device 100 may scroll the cartoon data.

In FIG. 5, a touch and drag is shown as the user input for scrolling the cartoon data, but the present invention is not limited thereto. That is, the cartoon data may be scrolled by various types of user inputs that may be recognized by the cartoon data display device 100 as a command for scrolling the cartoon data, such as a tap, a double tap, a long tap, a click, a double click, and a click and drag on an arbitrary or specific region of the cartoon data, a press on an arbitrary or specific keyboard button, or a user action of making a specific air gesture.

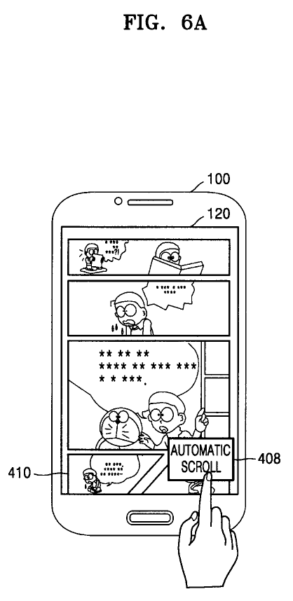

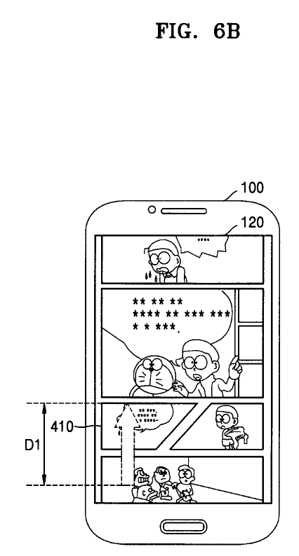

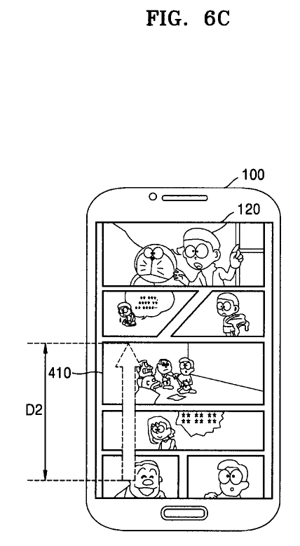

The cartoon data display device 100 may receive a user input for automatically scrolling the cartoon data while a region of the cartoon data is displayed on the display unit 120 and may automatically scroll the cartoon data displayed on the display unit 120. For example, as shown in FIG. 6A, the cartoon data display device 100 may display a region of the cartoon data while a second frame 410 is displayed on the bottom portion of the display unit 120. In this case, the cartoon data display device 100 may receive the user input for automatically scrolling the cartoon data. For example, as shown in FIG. 6A, the cartoon data display device 100 may detect a touch on a user interface (UI) 408 indicating the user requests an automatic scroll. When the touch on the UI 408 indicating an automatic scroll is detected, as shown in FIG. 6B, the cartoon data display device 100 may automatically scroll the cartoon data so that the second frame 410 gradually moves up.

The cartoon data display device 100 may automatically scroll the cartoon data at a speed proportional to an automatic scroll speed. Also, the cartoon data display device 100 may consider one or more of a cartoon reading speed of the user, a previous reading experience of the user, information directly entered by the user, characteristics for each region of the cartoon data, data set by an artist, and a cartoon reading speed of a user of an external device, and may determine a different automatic scroll speed depending on a result of the consideration. For example, the cartoon data display device 100 may determine a first automatic scroll speed in consideration of first considerations and also may determine a second automatic scroll speed in consideration of second considerations. As a result, the second frame 410 may move by a first distance D1 per unit of time, as shown in FIG. 6B, when the automatic scroll proceeds at the first automatic scroll speed, and may move a second distance D2 greater than the first distance D1 per unit of time, as shown in FIG. 6C, when the automatic scroll proceeds at the second automatic scroll speed. Thus, the cartoon data display device 100 may automatically scroll the cartoon data according to different automatic scroll speeds.

In FIG. 6A, the touch on the UI 408 for requesting the automatic scroll is shown as a user input for initiating a function of automatically scrolling the cartoon data, but the present invention is not limited thereto. That is, the function of automatically scrolling the cartoon data may be initiated by various types of user inputs that may be recognized by the cartoon data display device 100 as the command for automatically scrolling the cartoon data, such as a double tap, a long tap, a tap and drag, a click, a double click, and a click and drag on an arbitrary or specific region of the cartoon data, a press on an arbitrary or specific keyboard button, or a user action of making a specific air gesture.

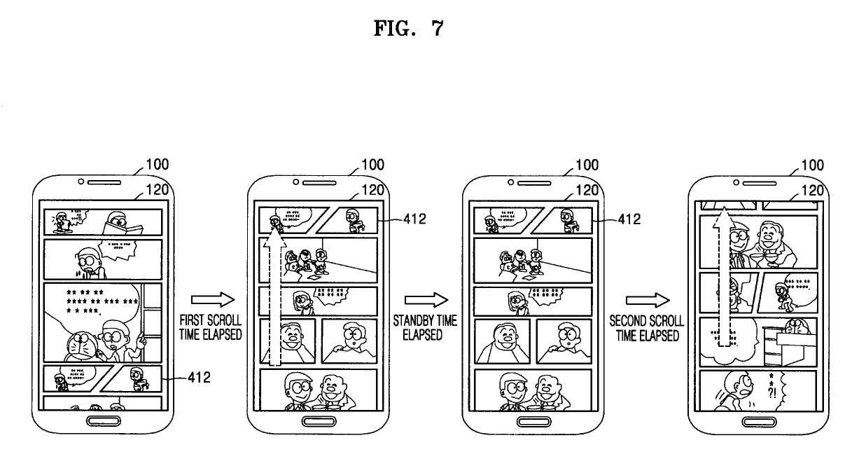

The cartoon data display device 100 may automatically scroll the cartoon data by a distance proportional to the automatic scroll speed per unit of time. Also, the cartoon data display device 100 may divide the unit of time into a scroll time and a standby time and may determine whether to perform a scroll according to the divided time. For example, as shown in the first drawing on the leftmost side of FIG. 7, the cartoon data display device 100 may display a region of the cartoon data while a third frame 412 is displayed on the bottom portion of the display unit 120. In this case, the cartoon data display device 100 may automatically scroll the cartoon data during a first scroll time. For example, as shown in the second drawing adjacent the first drawing of FIG. 7, the cartoon data display device 100 may automatically scroll the cartoon data during the first scroll time until the third frame 412 is displayed on the top portion of the display unit 120. Subsequently, the cartoon data display device 100 may pause the automatic scroll function during the standby time. For example, as shown in the third drawing adjacent the second drawing of FIG. 7, the cartoon data display device 100 may continue displaying the third frame 412 on the top portion of the display unit 120 during the standby time. Subsequently, the cartoon data display device 100 may automatically scroll the cartoon data during a second scroll time. For example, as shown in the fourth drawing adjacent the third drawing of FIG. 7, the cartoon data display device 100 may automatically scroll the cartoon data during the second scroll time so that the third frame 412 disappears from the display unit 120. Thus, the cartoon data display device 100 may provide a time for the user to read the cartoon data by scrolling the cartoon data for a certain time and then stopping the scroll for a certain time.

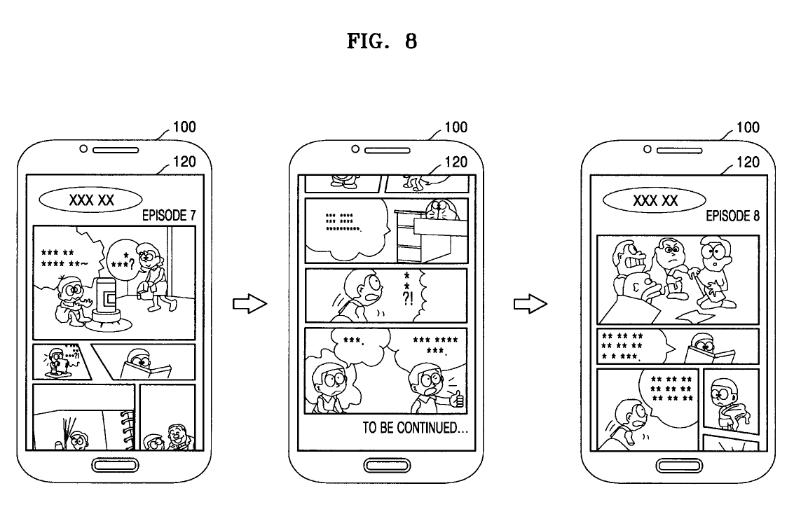

When first cartoon data is automatically scrolled to the last position thereof, the cartoon data display device 100 may automatically display, on the display unit 120, second cartoon data in the same series as and subsequent to the first cartoon data. For example, as shown in the first drawing on the leftmost side of FIG. 8, the cartoon data display device 100 may display cartoon data corresponding to episode 7 in a specific series on the display unit 120. Subsequently, the cartoon data display device 100 may automatically scroll the first cartoon data to the last position thereof. For example, as shown in the second drawing adjacent the first drawing of FIG. 8, the cartoon data display device 100 may automatically scroll the cartoon data corresponding to episode 7 in the series to the last position thereof on the display unit 120. Subsequently, the cartoon data display device 100 may automatically display the second cartoon data in the same series as and subsequent to the first cartoon data. For example, as shown in the third drawing adjacent second drawing of FIG. 8, the cartoon data display device 100 may display a first position of cartoon data corresponding to episode 8 in the series on the display unit 120. Subsequently, the cartoon data display device 100 may automatically scroll the corresponding cartoon data. Thus, the cartoon data display device 100 may enable a user to continuously read a plurality of pieces of cartoon data included in one series.

In FIG. 8, a case in which cartoon data is changed to subsequent cartoon data in the same series is shown, but the present invention is not limited thereto. That is, after cartoon data is automatically scrolled to the last position thereof, any cartoon data in the same series may be automatically displayed. Also, after the last cartoon data in a series is automatically scrolled to the last position thereof, first cartoon data in another series may be automatically displayed.

The above-described embodiments of the present invention may be implemented in the form of a computer program or program instruction that is executable through various computer components and recordable on a computer-readable recording medium. Examples of the computer-readable recording medium may include a magnetic medium such as a hard disk, a floppy disk, or a magnetic tape, an optical medium such as a compact disc-read only memory (CD-ROM) or a digital versatile disc (DVD), a magneto-optical medium such as a floptical disk, and a hardware device such as a ROM, a random access memory (RAM), or a flash memory that is specially designed to store and execute program instructions. The computer program or program instruction may be implemented in the form of software or an application and may be transmitted and distributed over the network.

The computer program may be designed and configured specially for the invention, and examples of the computer program include a high-level language code executable by a computer with an interpreter in addition to a machine language code made by a compiler.

The particular implementations shown and described herein are illustrative examples of embodiments and are not intended to otherwise limit the scope of embodiments in any way. For the sake of brevity, conventional electronics, control systems, software, and other functional aspects of the systems may not be described in detail. Furthermore, connecting lines or connectors shown in the various presented figures are intended to represent exemplary functional relationships and/or physical or logical couplings between the various elements. It should be noted that many alternative or additional functional relationships, physical connections or logical connections may be present in a practical device. Therefore, the spirit of the present invention is not to be limited by the aforementioned embodiments, and all changes within the claims and their legal equivalents should be construed as being included in the spirit of the present invention.

Embodiments of the present invention relate to a cartoon data display method and a cartoon data display device. The present invention may arouse interest in cartoon data of a user who is viewing the cartoon data and may enhance user convenience by determining an automatic scroll speed according to a cartoon reading speed of the user, whether the user has previously read the cartoon data, or input information directly entered by the user, scrolling the cartoon data by a distance proportional to the determined automatic scroll speed per unit of time, and displaying the scrolled cartoon data.

1. A cartoon data display method in which cartoon data is displayed on a display unit of a cartoon data display device, the cartoon data display method comprising:
displaying, by the display unit, a partial region of first cartoon data;
receiving, by a user input unit, a command for automatically scrolling the first cartoon data from a first user;
determining, by a control unit, an automatic scroll speed corresponding to cartoon reading information of the first user; and
controlling, by the control unit, the display unit according to the command such that the first cartoon data is automatically scrolled at the determined automatic scroll speed.

2. The cartoon data display method of claim 1, further comprising, before the determination of the automatic scroll speed, acquiring, by the control unit, the cartoon reading information by analyzing at least one of cartoon reading patterns of the first user.

3. The cartoon data display method of claim 2, wherein the acquiring the cartoon reading information comprises analyzing the at least one of the cartoon reading patterns of the first user in consideration of a time consumed by the first user performing a scroll in a reverse direction.

4. The cartoon data display method of claim 1, wherein:
the cartoon reading information of the first user includes a cartoon reading speed of the first user; and
the determining the automatic scroll speed comprises determining the automatic scroll speed to be proportional to the cartoon reading speed of the first user.

5. The cartoon data display method of claim 4, wherein the cartoon reading speed of the first user is any one of an average cartoon reading speed of the first user, a cartoon reading speed of the first user with respect to the same genre as that of the first cartoon data, a cartoon reading speed of the first user with respect to the same series as that of the first cartoon data, and a cartoon reading speed of the first user with respect to other cartoon data created by an artist of the first cartoon data.

6. The cartoon data display method of claim 1, wherein:
the cartoon reading information of the first user includes whether the first user has previously read the first cartoon data; and
the determining the automatic scroll speed comprises determining a higher automatic scroll speed when the first user has previously read the first cartoon data than when the first user first reads the first cartoon data.

7. The cartoon data display method of claim 1, wherein:
the cartoon reading information of the first user includes whether the first user has previously stopped reading the first cartoon data; and
the determining the automatic scroll speed comprises determining a higher automatic scroll speed before a first position of the first cartoon data when the first user has stopped the first cartoon data at the first position than when the first user first reads the first cartoon data.

8. The cartoon data display method of claim 1, wherein the cartoon reading information of the first user includes input information directly entered by the first user.

9. The cartoon data display method of claim 8, wherein the input information includes at least one of a cartoon reading speed of the first user, a reading speed of the first user, an age of the first user, a favorite genre of the first user, and a favorite scene of the first user.

10. The cartoon data display method of claim 1, wherein:
the determining the automatic scroll speed comprises determining an automatic scroll speed corresponding to characteristics for each region of the first cartoon data and also corresponding to the cartoon reading information of the first user; and
the characteristics for each of the regions of the first cartoon data include at least one of the number of frames included in each of the regions, frame details, the number of letters of text, the number of effects, a type of effect, the number of objects appearing, a type of object appearing, and whether advertising content is included.

11. The cartoon data display method of claim 1, wherein:
the determining the automatic scroll speed comprises determining an automatic scroll speed corresponding to data set by an artist of the first cartoon data and also corresponding to the cartoon reading information of the first user; and
the data set by the artist of the first cartoon data includes at least one of an importance level set for each region of the first cartoon data by the artist and an animation effect set by the artist for each of the regions of the first cartoon data.

12. The cartoon data display method of claim 1, wherein the controlling the display unit comprises controlling the display unit such that the first cartoon data is scrolled by a distance proportional to the automatic scroll speed per unit of time.

13. The cartoon data display method of claim 12, wherein:
the unit of time includes a standby time and a scroll time; and
the controlling the display unit comprises:
controlling, by the control unit, the display unit such that the region of the first cartoon data is fixedly displayed during the standby time; and
controlling, by the control unit, the display unit such that the first cartoon data is automatically scrolled during the scroll time.

14. The cartoon data display method of claim 1, wherein:
the determining the automatic scroll speed comprises determining an automatic scroll speed for a first region of the first cartoon data as a first automatic scroll speed and determining an automatic scroll speed for a second region of the first cartoon data as a second automatic scroll speed; and
the controlling the display unit comprises controlling the display unit such that the first region of the first cartoon data is scrolled at the first automatic scroll speed and controlling the display unit such that the second region of the first cartoon data is scrolled at the second automatic scroll speed.

15. The cartoon data display method of claim 1, further comprising, after the controlling of the display unit such that the first cartoon data is automatically scrolled, controlling, by the control unit, the display unit such that second cartoon data in the same series as and subsequent to the first cartoon data is displayed on the display unit.

16. The cartoon data display method of claim 1, further comprising, before the determination of the automatic scroll speed, receiving, by a communication unit, cartoon reading information of a second user from an external device, wherein
the determining the automatic scroll speed comprises determining an automatic scroll speed corresponding to the cartoon reading information of the first or second user.

17. A non-transitory computer readable recording medium storing a computer program for executing a cartoon data display method in which cartoon data is displayed on a display unit of a cartoon data display device, the computer program causing a computer to executes the steps comprising:
displaying, on the display unit, a partial region of first cartoon data;
receiving, through a user input unit, a command for automatically scrolling the first cartoon data from a first user;
determining an automatic scroll speed corresponding to cartoon reading information of the first user; and
controlling the display unit according to the command such that the first cartoon data is automatically scrolled at the determined automatic scroll speed.

18. A distribution server configured to distribute a program for executing a cartoon data display method in which cartoon data is displayed on a display unit of a cartoon data display device, the program causing a computer to execute the steps comprising:
displaying, on the display unit, a partial region of first cartoon data;
receiving, through a user input unit, a command for automatically scrolling the first cartoon data from a first user;
determining an automatic scroll speed corresponding to cartoon reading information of the first user; and
controlling the display unit according to the command such that the first cartoon data is automatically scrolled at the determined automatic scroll speed.
